(19) United States
(12) Patent Application Publication
(10) Pub. No.: US 2026/0163060 A1
(43) Pub. Date: Jun. 11, 2026

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Sanghyung KIM, Yongin-si (KR); TAE HYON BAE, Yongin-si (KR); Harim LEE, Yongin-si (KR); Seunghyeon SON, Yongin-si (KR); Sangheon LEE, Yongin-si (KR); CHEONSOO KIM, Yongin-si (KR)

(21) Appl. No.: 19/181,092

(22) Filed: Apr. 16, 2025

(30) Foreign Application Priority Data
Sep. 9, 2024 (KR) 10-2024-0122599

(51) Int. Cl. H01M 10/0567; H01M 4/02; H01M 4/131; H01M 4/133; H01M 4/134; H01M 4/38; H01M 4/485; H01M 4/587; H01M 10/0525; H01M 10/0568; H01M 10/0569

(52) U.S. Cl. CPC H01M 10/0567; H01M 4/131; H01M 4/133; H01M 4/134; H01M 4/386; H01M 4/387; H01M 4/485; H01M 4/587; H01M 10/0525; H01M 10/0568; H01M 10/0569; H01M 2004/027; H01M 2004/028; H01M 2300/0037

(57) ABSTRACT

An electrolyte and a rechargeable lithium battery including the electrolyte are disclosed. The electrolyte may include a non-aqueous (e.g., water-insoluble) organic solvent including a first compound as represented by Chemical Formula 1, a lithium salt, a first additive as represented by Chemical Formula 2, and a second additive as represented by Chemical Formula 3.

### CROSS-REFERENCE TO RELATED APPLICATION

The present application claims priority to and the benefit of Korean Patent Application No. 10-2024-0122599, filed on Sep. 9, 2024, in the Korean Intellectual Property Office, the entire disclosure of which is incorporated herein by reference.

### BACKGROUND

### 1. Field

One or more embodiments of the present disclosure relate to an electrolyte for a rechargeable lithium battery and a rechargeable lithium battery including the electrolyte.

### 2. Description of the Related Art

With the rapid spread of battery-utilizing electronic devices, such as mobile phones and laptop computers, and electric vehicles, it is desirable to develop rechargeable lithium batteries having high energy density and high capacity (e.g., electrical capacity). Research and development have been conducted to improve performance of rechargeable lithium batteries.

Rechargeable lithium batteries include a positive electrode, a negative electrode, and an electrolyte, which the positive electrode and the negative electrode include an active material in which intercalation and deintercalation may take place, and generate electrical energy caused by oxidation and reduction reactions if (e.g., when) lithium ions are intercalated and deintercalated.

A lithium salt dissolved in a non-aqueous (e.g., water-insoluble) organic solvent is used as the electrolyte of the rechargeable lithium batteries. Characteristics of the rechargeable lithium batteries are exhibited by complex electrochemical reactions between the positive electrode and the electrolyte and/or between the negative electrode and the electrolyte. The use of an appropriate or suitable electrolyte is one of the important variables for improvement or enhancement of the rechargeable lithium batteries.

### SUMMARY

One or more aspects of embodiments of the present disclosure are directed toward an electrolyte for a rechargeable lithium battery having improved or enhanced stability (e.g., electrochemical stability, thermal stability, and/or physical stability) and lifespan characteristics at relatively high voltages.

One or more aspects of embodiments of the present disclosure are directed toward a rechargeable lithium battery including the electrolyte as described in one or more embodiments.

Additional aspects of embodiments will be set forth in part in the description which follows and, in part, will be apparent from the description or may be learned by practice of the presented embodiments of the disclosure.

According to one or more embodiments of the present disclosure, an electrolyte for a rechargeable lithium battery may include: a non-aqueous (e.g., water-insoluble) organic solvent including a first compound as represented by Chemical Formula 1; a lithium salt; a first additive as represented by Chemical Formula 2; and a second additive as represented by Chemical Formula 3.

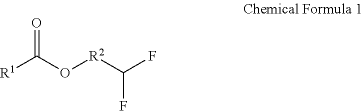

In Chemical Formula 1,
R¹ may be a substituted or unsubstituted C1 to C6 alkyl group or a substituted or unsubstituted C5 to C12 aryl group, and
R² may be a direct bond (e.g., a single covalent bond) or a C1 to C6 alkylene group.

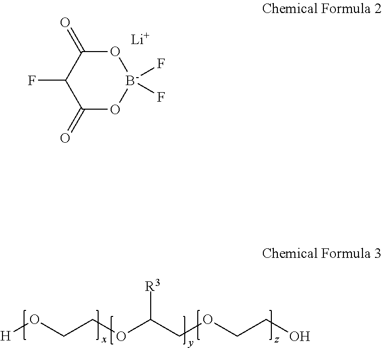

In Chemical Formula 3,
R³ may be hydrogen or a substituted or unsubstituted C1 to C10 alkyl group, and

The subscripts x, y, and z may each independently be an integer of 1 to 20.

According to one or more embodiments of the present disclosure, a rechargeable lithium battery may include: a positive electrode that includes a positive electrode active material; a negative electrode that includes a negative electrode active material; and the electrolyte for the rechargeable lithium battery as described in one or more embodiments.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a simplified conceptual diagram illustrating a rechargeable lithium battery according to one or more embodiments of the present disclosure.

FIGS. 2-5 each is a diagram illustrating a rechargeable lithium battery according to one or more embodiments of the present disclosure, with FIG. 2 illustrating a cylindrical rechargeable lithium battery, FIG. 3 illustrating a prismatic rechargeable lithium battery, and FIGS. 4 and 5 illustrating pouch-type or -kind rechargeable lithium batteries.

FIG. 6 is a photograph illustrating the results of impregnation of an electrolyte to the negative electrodes of Embodiment 9, Comparative 1, and Comparative 3.

### DETAILED DESCRIPTION

In order to fully understand the aspects and features of the present disclosure, the subject matter of the present disclosure will be described below in more detail with reference to the accompanying drawings. It should be noted, however, that the subject matter of the present disclosure is not limited to the disclosed embodiments and may be implemented in one or more suitable forms. Rather, these embodiments are provided as examples so that this disclosure will be thorough and complete and will fully convey the aspects and features of the present disclosure to those skilled in the art.

As utilized herein, the singular forms “a,” “an,” and “the” are intended to include the plural forms as well, unless the context clearly indicates otherwise. Further, the utilization of “may” if (e.g., when) describing embodiments of the present disclosure refers to “one or more embodiments of the present disclosure.”

In the context of the present disclosure and unless otherwise defined, the terms “use,” “using,” and “used” may be considered synonymous with the terms “utilize,” “utilizing,” and “utilized,” respectively.

As utilized herein, the term “about” or similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and refers to within an acceptable range of deviation for the particular value as determined by one of ordinary skill in the art, considering the measurement in question and the error associated with measurement of the particular quantity (e.g., the limitations of the measurement system). For example, “about” may refer to being within one or more standard deviations, or within ±30%, ±20%, ±10%, or ±5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, for example, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

In the present disclosure, it will be understood that, if (e.g., when) an element is referred to as being “on” another element, the element may be directly on the other element or intervening elements may be present therebetween. In contrast, if (e.g., when) an element is referred to as being “directly on” another element, there are no intervening elements present therebetween.

In the drawings, thicknesses of one or more components may be exaggerated to effectively or suitably illustrate the technical contents of the present disclosure.

Like reference numerals refer to like elements throughout the specification.

Unless otherwise noted in the present disclosure, the expression of singular form may include the expression of plural form. In embodiments, unless otherwise noted, the phrase “A or B” may indicate “A but not B”, “B but not A”, and “A and B”.

The terms “includes/has” and/or “including/having” used in the present disclosure do not exclude the presence or addition of one or more other components.

In the present disclosure, it will be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

In the present disclosure, the term “combination thereof” may refer to a mixture, a stack, a composite, a copolymer, an alloy, a blend, a reaction product, and/or the like of the constituents.

Unless otherwise defined in the present disclosure, a particle diameter may be an average particle diameter. In one or more embodiments, a particle diameter indicates an average particle diameter (D₅₀) where a cumulative volume is about 50 volume % in a particle size distribution. The average particle diameter (D₅₀) may be measured by a method that is generally available to or generally used by those skilled in the art, for example, by a particle size analyzer and/or may also be measured by utilizing a transmission electron microscope (TEM) image and/or a scanning electron microscope (SEM) image. In one or more embodiments, a dynamic light scattering (DLS) measurement device is used to perform a data analysis, the number of particles is counted for each particle size range, and then from this data, an average particle diameter (D₅₀) value may be obtained through a calculation. In one or more embodiments, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device. As used herein, if (e.g., when) a definition is not otherwise provided, the average particle diameter refers to a diameter (D₅₀) of particles having a cumulative volume of 50 volume % in the particle size distribution that is obtained by measuring the size (e.g., diameter or major axis length) of about 20 particles at random in a scanning electron microscope image. In one or more embodiments, if (e.g., when) particles are spherical (e.g., substantially spherical), “diameter” or “size” refers to a particle diameter, and if (e.g., when) the particles are non-spherical (e.g., substantially non-spherical), the “diameter” or “size” refers to a major axis length.

In the present disclosure, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 aryl silyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, or a combination thereof.

In more detail, the term “substituted” may refer to that at least one hydrogen of a substituent or a compound is substituted by deuterium, a halogen group, a C1 to C30 alkyl group, a C1 to C10 alkylsilyl group, a C6 to C30 aryl silyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may refer to that at least one hydrogen of a substituent or a compound is substituted by deuterium, a halogen group, a C1 to C20 alkyl group, a C6 to C30 aryl group, a C1 to C10 fluoroalkyl group, or a cyano group. In one or more embodiments, the term “substituted” may refer to that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may refer to that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluoromethyl group, or a naphthyl group.

Unless otherwise defined in the present disclosure, the mark “*” may refer to a portion that is connected to the same or different atom or chemical formula.

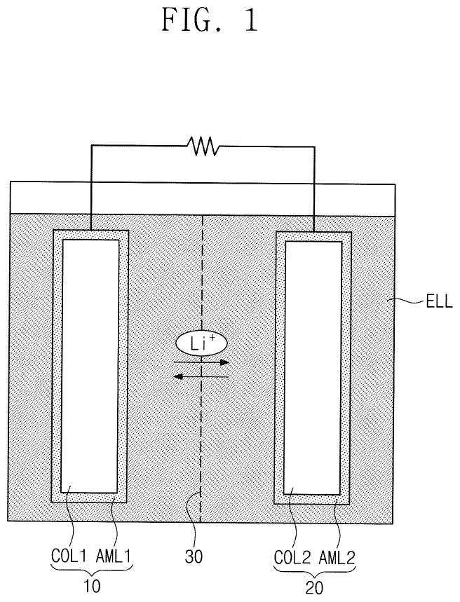

FIG. 1 is a simplified conceptual diagram illustrating a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in/with the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode

The positive electrode 10 for the rechargeable lithium battery may include a current collector COL1 and a positive electrode active material layer AML1 on the current collector COL1. The positive electrode active material layer AML1 may include a positive electrode active material and may further include a binder and/or a conductive (e.g., electrically conductive) material (e.g., an electron conductor).

An amount of the positive electrode active material may be about 90 wt % to about 99.5 wt % relative to 100 wt % (e.g., based on 100 wt % of a total weight) of the positive electrode active material layer AML1. An amount of each of the binder and the conductive (e.g., electrically conductive) material may be about 0.5 wt % to about 5 wt % relative to 100 wt % (e.g., based on 100 wt % of a total weight) of the positive electrode active material layer AML1.

The binder may serve to improve or enhance attachment of positive electrode active material particles to each other and also to improve or enhance attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and/or nylon, but embodiments of the present disclosure are not limited thereto.

The conductive (e.g., electrically conductive) material (e.g., an electron conductor) may be used to provide an electrode with conductivity (e.g., electrical conductivity), and any suitable conductive (e.g., electrically conductive) material that does not cause a chemical change (e.g., an undesirable chemical change) in a rechargeable lithium battery may be used as the conductive (e.g., electrically conductive) material. The conductive (e.g., electrically conductive) material (e.g., an electron conductor) may include, for example, a carbon-based material, such as natural graphite, artificial graphite, carbon black, acetylene black, Ketjen black, carbon fiber, carbon nano-fiber, and/or carbon nano-tube; a metal powder and/or a metal fiber containing one or more of copper, nickel, aluminum, and/or silver; a conductive (e.g., electrically conductive) polymer, such as polyphenylene and/or a polyphenylene derivative; and/or a mixture thereof.

Aluminum (Al) may be used as the current collector COL1, but embodiments of the present disclosure are not limited thereto.

### Positive Electrode Active Material

The positive electrode active material in the positive electrode active material layer AML1 may include a compound (e.g., a lithiated intercalation compound) that may reversibly intercalate and deintercalate lithium. For example, the positive electrode active material may include at least one kind of composite oxide including lithium and metal that is selected from among cobalt, manganese, nickel, and a combination thereof.

The composite oxide may include a lithium transition metal composite oxide, for example, a lithium-nickel-based oxide, a lithium-cobalt-based oxide, a lithium-manganese-based oxide, a lithium-iron-phosphate-based compound, a cobalt-free nickel-manganese-based oxide, and/or or a combination thereof.

For example, the positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to (e.g., based on) 100 mol % of metal devoid of lithium in the lithium transition metal composite oxide. The high-nickel-based positive electrode active material may achieve or provide high capacity (e.g., electrical capacity) and thus may be applied to a high-capacity (e.g., electrical capacity) and high-density rechargeable lithium battery.

### Negative Electrode

The negative electrode 20 for a rechargeable lithium battery may include a current collector COL2 and a negative electrode active material layer AML2 on the current collector COL2. The negative electrode active material layer AML2 may include a negative electrode active material and may further include a binder and/or a conductive (e.g., electrically conductive) material (e.g., an electron conductor).

For example, the negative electrode active material layer AML2 may include a negative electrode active material of about 90 wt % to about 99 wt %, a binder of about 0.5 wt % to about 5 wt %, and a conductive (e.g., electrically conductive) material of about 0 wt % to about 5 wt % based on 100 wt % of a total weight of the negative electrode active material layer.

The binder may serve to improve or enhance attachment of negative electrode active material particles to each other and also to improve or enhance attachment of the negative electrode active material to the current collector COL2. The binder may include a non-aqueous (e.g., water-insoluble) binder, an aqueous (e.g., water-soluble) binder, a dry binder, or a combination thereof.

The non-aqueous (e.g., water-insoluble) binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide imide, polyimide, or a combination thereof.

The aqueous (e.g., water-soluble) binder may include a styrene-butadiene rubber, a (meth)acrylated styrene-butadiene rubber, a (meth)acrylonitrile-butadiene rubber, a (meth)acrylic rubber, a butyl rubber, a fluoro elastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenolic resin, an epoxy resin, polyvinyl alcohol, or a combination thereof.

If (e.g., when) an aqueous (e.g., water-soluble) binder is used as the negative electrode binder, a cellulose-based compound capable of providing or increasing viscosity may further be included. The cellulose-based compound may include one or more selected from among carboxymethyl cellulose, hydroxypropyl methylcellulose, methyl cellulose, and/or alkali metal salts thereof. The alkali metal may include sodium (Na), potassium (K), and/or lithium (Li).

The dry binder may include a fibrillizable polymer material, for example, polytetrafluoroethylene, polyvinylidene fluoride, a polyvinylidene fluoride-hexafluoropropylene copolymer, polyethylene oxide, or a combination thereof.

The conductive (e.g., electrically conductive) material (e.g., an electron conductor) may be used to provide an electrode with conductivity (e.g., electrical conductivity), and any suitable conductive (e.g., electrically conductive) material that does not cause a chemical change (e.g., an undesirable chemical change) in a rechargeable lithium battery may be used as the conductive (e.g., electrically conductive) material. For example, the conductive (e.g., electrically conductive) material (e.g., an electron conductor) may include a carbon-based material, such as natural graphite, artificial graphite, carbon black, acetylene black, Ketjen black, carbon fiber, carbon nano-fiber, and/or carbon nano-tube; a metal powder and/or a metal fiber including one or more selected from among copper, nickel, aluminum, and/or silver; a conductive (e.g., electrically conductive) polymer, such as polyphenylene and/or a polyphenylene derivative; and/or a mixture thereof.

The current collector COL2 may include a copper foil, a nickel foil, a stainless-steel foil, a titanium foil, a nickel foam, a copper foam, a polymer substrate coated with a conductive (e.g., electrically conductive) metal, and/or a combination thereof.

### Negative Electrode Active Material

The negative electrode active material in the negative electrode active material layer AML2 may include a material that may reversibly intercalate and deintercalate lithium ions, lithium metal, a lithium metal alloy, a material that may dope and de-dope lithium, and/or transition metal oxide.

The material that may reversibly intercalate and deintercalate lithium ions may include a carbon-based negative electrode active material, for example, crystalline carbon, amorphous (e.g., non-crystalline) carbon, or a combination thereof. For example, the crystalline carbon may include graphite, such as non-shaped (e.g., substantially non-shaped), sheet-shaped (e.g., substantially sheet-shaped), flake-shaped (e.g., substantially flake-shaped), sphere-shaped (e.g., substantially sphere-shaped), or fiber-shaped (e.g., substantially fiber-shaped) natural graphite and/or artificial graphite, and the amorphous (e.g., non-crystalline) carbon may include soft carbon, hard carbon, mesophase pitch carbon, calcined coke, and/or the like.

The lithium metal alloy may include an alloy of lithium and metal that is selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material that may dope and de-dope lithium may include a Si-based negative electrode active material and/or a Sn-based negative electrode active material. The Si-based negative electrode active material may include silicon, silicon-carbon composite, SiOₓ (where 0<x≤2; e.g., SiO₂), Si-Q alloy (where Q may be alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include Sn, SnOₖ (where 0<k≤2) (e.g., SnO₂), a Sn-based alloy, a combination thereof.

The silicon-carbon composite may be a composite of silicon and amorphous (e.g., non-crystalline) carbon. According to one or more embodiments, the silicon-carbon composite may have a structure in which the amorphous (e.g., non-crystalline) carbon is coated on a surface of the silicon particle. For example, the silicon-carbon composite may include a secondary particle (core) in which primary silicon particles are assembled and an amorphous (e.g., non-crystalline) carbon coating layer (shell) on a surface of the secondary particle. The amorphous (e.g., non-crystalline) carbon may also be between the primary silicon particles, and for example, the primary silicon particles may be coated with the amorphous (e.g., non-crystalline) carbon. The secondary particles may be present dispersed in an amorphous (e.g., non-crystalline) carbon matrix.

The silicon-carbon composite may further include crystalline carbon. For example, the silicon-carbon composite may include a core including crystalline carbon and silicon particles and may also include an amorphous (e.g., non-crystalline) carbon coating layer on a surface of the core.

The Si-based negative electrode active material and/or the Sn-based negative electrode active material may be used in combination with a carbon-based negative electrode active material.

### Separator

Based on a type or kind of the rechargeable lithium battery, the separator 30 may be between the positive electrode 10 and the negative electrode 20. The separator 30 may include one or more selected from among polyethylene, polypropylene, and polyvinylidene fluoride and may have a multi-layered separator thereof, such as a polyethylene/polypropylene bi-layered separator, a polyethylene/polypropylene/polyethylene tri-layered separator, and/or a polypropylene/polyethylene/polypropylene tri-layered separator.

The separator 30 may include a porous substrate and a coating layer on one surface or both surfaces (e.g., two opposing surfaces) of the porous substrate, which the coating layer may include an organic material, an inorganic material, or a combination thereof.

The porous substrate may be a polymer layer including one selected from among polyolefin, such as polyethylene and polypropylene, polyester, such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, a cyclic olefin copolymer, polyphenylenesulphide, polyethylene naphthalate, a glass fiber, and polytetrafluoroethylene (Teflon™), or may be a copolymer or mixture including two or more of the materials as described in one or more embodiments.

The organic material may include a polyvinylidenefluoride-based copolymer and/or a (meth)acrylic copolymer.

The inorganic material may include an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but embodiments of the present disclosure are not limited thereto.

The organic material and the inorganic material may be present mixed in one coating layer or may be present as a stack of a coating layer including the organic material and a coating layer including an inorganic material.

### Electrolyte

The electrolyte ELL for a rechargeable lithium battery may include a non-aqueous (e.g., water-insoluble) organic solvent and a lithium salt.

The non-aqueous (e.g., water-insoluble) organic solvent may serve as a medium to transmit ions that participate in an electrochemical reaction of the rechargeable lithium battery.

The non-aqueous (e.g., water-insoluble) organic solvent may include a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, propyl propionate (PP), and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone and/or the like. The alcohol-based solvent may include ethyl alcohol, isopropyl alcohol, and/or the like, and the aprotic solvent may include nitriles, such as R—CN (where R may be a hydrocarbon group having a C2 to C20 linear, branched, or cyclic structure and may include a double bond, an aromatic ring, and/or an ether group); amides, such as dimethylformamide and/or the like; dioxolanes, such as 1,3-dioxolane 1,4-dioxolane, and/or the like; sulfolanes, and/or the like.

The non-aqueous (e.g., water-insoluble) organic solvent may be used alone or in a mixture of two or more substances.

In one or more embodiments, if (e.g., when) a carbonate-based solvent is used, a cyclic carbonate and a linear carbonate may be mixed and used, and the cyclic carbonate and the linear carbonate may be mixed in a volume ratio of about 1:1 to about 1:9.

The lithium salt may be a material that is dissolved in the non-aqueous (e.g., water-insoluble) organic solvent to serve as a supply source of lithium ions in a rechargeable lithium battery and plays a role in enabling a basic operation of a rechargeable lithium battery and in promoting or enhancing the movement of lithium ions between the positive electrode and the negative electrode. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(CyF_{2y+1}SO₂) (where x and y may each independently be an integer of 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), and lithium bis(oxalato)borate (LiBOB).

An electrolyte for a rechargeable lithium battery according to one or more embodiments of the present disclosure will be described in more detail herein.

An electrolyte for a rechargeable lithium battery according to one or more embodiments may include a non-aqueous (e.g., water-insoluble) organic solvent including a first compound as represented by Chemical Formula 1 which will be discussed in more detail herein, a lithium salt, a first additive as represented by Chemical Formula 2 which will be discussed in more detail herein, and a second additive as represented by Chemical Formula 3 which will be discussed in more detail herein.

The electrolyte may be prepared or provided by a mixing process in which the lithium salt is dissolved in the non-aqueous (e.g., water-insoluble) organic solvent and the additive is added to mix. The electrolyte mixing process may be generally available or generally used in the electrolyte fabrication field, and a person skilled in the art will be able to appropriately or suitably select and use.

### Non-Aqueous Organic Solvent

The non-aqueous (e.g., water-insoluble) organic solvent according to one or more embodiments of the present disclosure may include a fluorine-based solvent. The fluorine-based solvent may include the first compound. The first compound may be a difluoroacetate compound. The first compound may be represented by Chemical Formula 1.

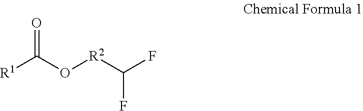

In Chemical Formula 1,
R¹ may be a substituted or unsubstituted C1 to C6 alkyl group or a substituted or unsubstituted C5 to C12 aryl group.
R² may be a direct bond (e.g., a single covalent bond) or a C1 to C6 alkylene group.

For example, R¹ may be a substituted or unsubstituted C1 to C6 alkyl group, and R² may be a C1 to C6 alkylene group.

The first compound according to one or more embodiments of the present disclosure may be 2,2-difluoroethyl acetate (DFEA) as represented by Chemical Formula 1-1.

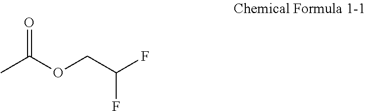

For example, the first compound may be used to increase an amount of fluorine (e.g., fluorine atoms) in the electrolyte. In one or more embodiments, the rechargeable lithium battery may improve or enhance oxidation resistance and flame retardancy. In one or more embodiments, the rechargeable lithium battery may have improved or enhanced lifespan characteristics.

For example, as 2,2-difluoroethyl acetate (DFEA) structurally includes two fluorine (F) atoms, chemical stability (e.g., electrochemical stability) and/or thermal stability may be improved or enhanced, and a flash point of a solvent may be increased. In one or more embodiments, the electrolyte may be prevented from being overheated and/or easily ignited in an overcharged state (or a degree to or occurrence of which the electrolyte is overheated and/or easily ignited in an overcharged state may be reduced). In one or more embodiments, the first compound including a fluorine atom (or fluorine atoms) may emit a fluorinated gas during combustion, and the fluorinated gas may suppress combustion (or reduce a degree or occurrence of combustion) and prevent the spread of fire (or reduce a degree or occurrence of the spread of fire). In one or more embodiments, the resultant rechargeable lithium battery may have improved or enhanced stability (e.g., electrochemical stability, thermal stability, and/or physical stability).

The first compound may be in an amount of about 50 vol % to about 85 vol %, about 55 vol % to about 80 vol %, or about 60 vol % to about 75 vol % relative to (e.g., based on 100 vol % of) the total volume of the non-aqueous (e.g., water-insoluble) organic solvent. If (e.g., when) the amount of the first compound falls within the foregoing ranges, a capacity retention rate of the rechargeable lithium battery may be prevented from reduction due to excessive introduction of fluorine while sufficiently or suitably maintaining an amount of fluorine in the electrolyte. The non-aqueous (e.g., water-insoluble) organic solvent according to one or more embodiments of the present disclosure may contain a difluoroacetate compound to exhibit or provide oxidation resistance, thereby improving or enhancing charge-discharge characteristics at relatively high voltages.

The non-aqueous (e.g., water-insoluble) organic solvent may further include a carbonate-based solvent. The non-aqueous (e.g., water-insoluble) organic solvent according to one or more embodiments of the present disclosure may be a mixture of the difluoroacetate compound and the carbonate-based solvent.

The carbonate-based solvent may include one or more selected from among ethylene carbonate (EC), propylene carbonate (PC), ethyl methyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

In one or more embodiments, the non-aqueous (e.g., water-insoluble) organic solvent may be a mixture solvent of 2,2-difluoroethyl acetate (DFEA), ethylene carbonate (EC), and propyl carbonate (PC).

For example, the ethylene carbonate (EC) may be included in an amount of about 5 vol % to about 30 vol % relative to (e.g., based on 100 vol % of) the total volume of the non-aqueous (e.g., water-insoluble) organic solvent. The propylene carbonate (PC) may be included in an amount of about 10 vol % to about 40 vol % relative to (e.g., based on 100 vol % of) the total volume of the non-aqueous (e.g., water-insoluble) organic solvent.

If (e.g., when) the type or kind and the volume ratio of the organic solvent are satisfied, the additive may appropriately or suitably maintain its solubility. These embodiments, however, are provided as examples of the present disclosure, and embodiments of the present disclosure are not limited thereto.

### First Additive

The first additive according to one or more embodiments of the present disclosure may be lithium fluoromalonato(difluoro)borate as represented by Chemical Formula 2.

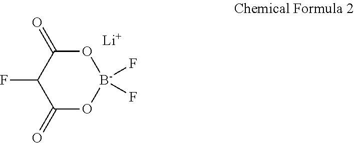 [SMILES: O=C1O[B-](F)(F)OC(=O)C1F ; [Li+]]

The first additive may have an effect of protecting the films having passivation ability that are on surfaces of the positive electrode and the negative electrode. In one or more embodiments, the film on the surface of the positive electrode may be referred to as a cathode electrolyte interface (CEI), and the film on the surface of the negative electrode may be referred to as a solid electrolyte interface (SEI). For example, the first additive having a cyclic borate structure may be ionized into lithium ions (Li⁺), fluoromalonic acid ions (C₃H₂F₂O₄²⁻), and difluoroborate ions (BF₂⁻) in the electrolyte. The ions may freely move or flow in the electrolyte to facilitate or enhance the movement of lithium ions (Li⁺), thereby maintaining or providing relatively high ionic conductivity. This phenomenon may stabilize the lithium salt in the electrolyte and protect the film. It may thus minimize the issues of rechargeable lithium battery lifespan reduction and resistance increase that occur if (e.g., when) the film on the surfaces of the positive electrode and the negative electrode are attacked by (or react with) the acid and/or a decomposition product of the lithium salt in the electrolyte. The film protection effect may contribute to an improvement or enhancement of the lifespan characteristics and a reduction in the internal resistance of the rechargeable lithium battery, for example, at relatively high voltages and/or relatively high temperatures.

The first additive may have an effect of reinforcing the film on the surface of the negative electrode in addition to the effect of protecting the films on the surfaces of the positive electrode and the negative electrode. As the first additive accelerates or enhances the efficient or suitable movement of lithium ions, the rechargeable lithium battery may improve or enhance the lifespan characteristics and decrease the internal resistance (e.g., electrical resistance). The film protection effect may contribute to an improvement or enhancement of the lifespan characteristics and a reduction in the internal resistance (e.g., electrical resistance) of the rechargeable lithium battery, for example, at relatively high temperatures.

In one or more embodiments, the first additive may improve or enhance the thermal stability and/or the electrochemical stability of the electrolyte, and the rechargeable lithium battery including the first additive may stably or suitably operate even at relatively high temperatures and/or relatively high voltages.

The first additive may be in an amount of about 0.1 wt % to about 5 wt % relative to 100 wt % (e.g., based on 100 wt % of a total weight) of the electrolyte for the rechargeable lithium battery. For example, the first additive may be in an amount of about 0.1 wt % to about 3 wt % or about 0.1 wt % to about 1 wt % relative to 100 wt % (e.g., based on 100 wt % of a total weight) of the electrolyte for the rechargeable lithium battery. The amount of the first additive may refer to a weight of the first additive included in the electrolyte relative to the total weight (e.g., based on 100 wt % of a total weight) of the electrolyte. If (e.g., when) the amount of the first additive falls within the foregoing ranges, the effects of protecting the films on the surfaces of the positive electrode and the negative electrode, of generating the film on the surface of the positive electrode, and of reinforcing the film on the surface of the negative electrode may be maximum or may increase to maximize or increase an improvement or enhancement of the lifespan characteristics and a reduction in the internal resistance (e.g., electrical resistance) of the rechargeable lithium battery.

### Second Additive

The second additive according to one or more embodiments of the present disclosure may be represented by Chemical Formula 3.

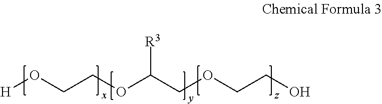

In Chemical Formula 3,

R³ may be hydrogen or a substituted or unsubstituted C1 to C10 alkyl group. For example, R³ may be a methyl group.

In Chemical Formula 3,

The subscripts x, y, and z may each independently be an integer of 1 to 20.

For example, a molar ratio of x:y may range from about 10:1 to about 1:10, from about 5:1 to about 1:5, or from about 3:1 to about 1:3. In one or more embodiments, a molar ratio of y:z may range from about 10:1 to about 1:10, from about 5:1 to about 1:5, or from about 3:1 to about 1:3.

The second additive may have a number average molecular weight (MC) of about 500 g/mol to 10,000 g/mol, about 700 g/mol to 8,000 g/mol, or about 1,000 g/mol to 2,000 g/mol. If (e.g., when) the number average molecular weight (MC) of the second additive is greater than about 10,000 g/mol, viscosity of the electrolyte including the second additive may be excessively increased to reduce wettability to the positive electrode and the negative electrode.

The second additive may serve as a surfactant having both (e.g., concurrently) of hydrophilic groups and hydrophobic groups in one molecule. The second additive may include a *—[O—CH(R³)—CH₂]_{y}—* block on a center thereof, and may also include a *—[O—CH₂—CH₂]ₓ—* block and a *—[O—CH₂—CH₂]_{z}—* block on opposite sides of the *—[O—CH(R³)—CH₂]_{y}—* block. In this configuration or arrangement, the *—[O—CH(R³)—CH₂]_{y}—* block may be a hydrophobic block, and each of the *—[O—CH₂—CH₂]ₓ—* block and the *—[O—CH₂—CH₂]_{z}—* block may be a hydrophilic block. If (e.g., when) the number average molecular weight (Mₙ) of the second additive is less than about 10,000 g/mol, the second additive may have a minimal or reduced effect as a surfactant.

An example of the second additive may be as follows.

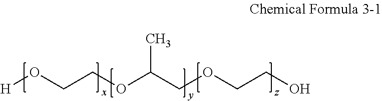

The second additive as represented by Chemical Formula 3-1 may be poly(ethylene glycol)-block-poly(propylene glycol)-block-poly(ethylene glycol) (PEG-b-PPG-b-PEG).

In Chemical Formula 3-1, the definition of x, y, and z may be as described in one or more embodiments.

The second additive may be in an amount of about 0.01 wt % to about 5 wt % relative to 100 wt % (e.g., based on 100 wt % of a total weight) of the electrolyte for the rechargeable lithium battery. For example, the second additive may be in an amount of about 0.01 wt % to about 3 wt %, about 0.01 wt % to about 1 wt %, or about 0.01 wt % to about 0.2 wt % relative to 100 wt % (e.g., based on 100 wt % of a total weight) of the electrolyte for the rechargeable lithium battery. The amount of the second additive may refer to a weight of the second additive included in the electrolyte relative to the total weight (e.g., based on 100 wt % of a total weight) of the electrolyte. If (e.g., when) the amount of the second additive falls within the foregoing ranges, the second additive may have a maximal or increased effect as a surfactant.

A synergistic effect may occur if (e.g., when) the first additive and the second additive are used in combination with the difluoroacetate compound (e.g., the first compound) included in the non-aqueous (e.g., water-insoluble) organic solvent. The combination thereof may effectively or suitably improve or enhance the lifespan characteristics of the rechargeable lithium battery. For example, an effect of improving or enhancing a flame retardancy of the first compound, an effect of forming or providing an excellent or suitable film of the first additive, and an effect of enhancing electrode plate impregnation of the second additive may concurrently (e.g., simultaneously) occur to maximize or increase the lifespan characteristics and the stability (e.g., electrochemical stability, thermal stability, and/or physical stability) of the rechargeable lithium battery. This synergistic effect may become pronounced or provided, for example, at relatively high voltages and/or relatively high temperatures.

### Lithium Salt

In one or more embodiments, LiPF₆ may be used as the lithium salt.

The lithium salt may have a concentration of about 0.1 M to about 2.0 M. For example, the lithium salt may have a concentration of equal to or greater than about 0.5 M or equal to or greater than about 1.0 M. The lithium salt may have a concentration of equal to or less than about 2.0 M, equal to or less than about 1.7 M, or equal to or less than about 1.5 M. In the present disclosure, if (e.g., when) the lithium salt has a concentration of about 0.1 M to about 2.0 M, the electrolyte may appropriately or suitably maintain or provide its conductivity (e.g., electrical conductivity) and viscosity.

### Rechargeable Lithium Battery

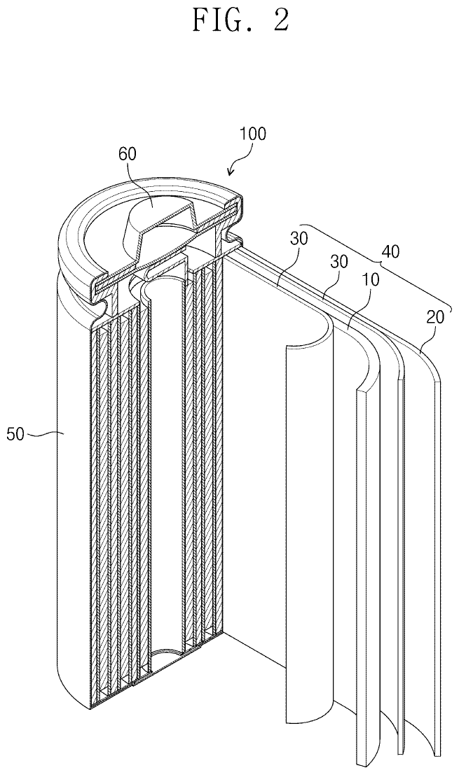

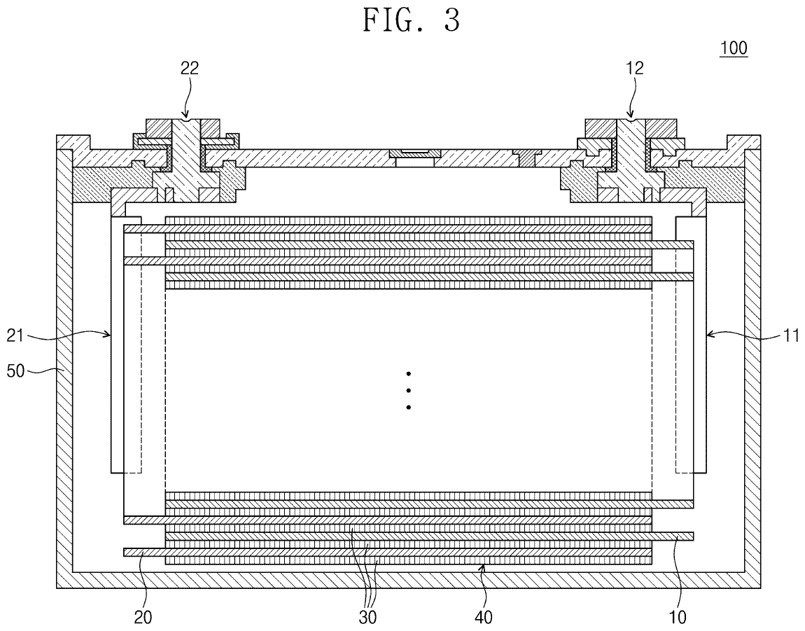

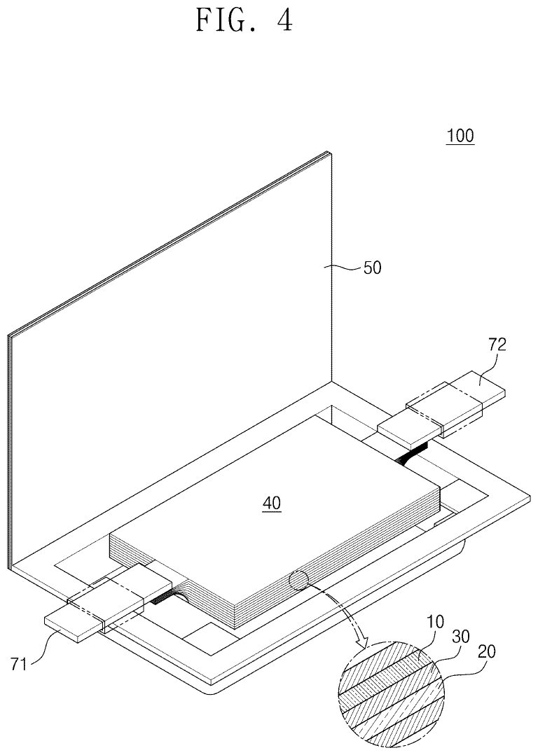

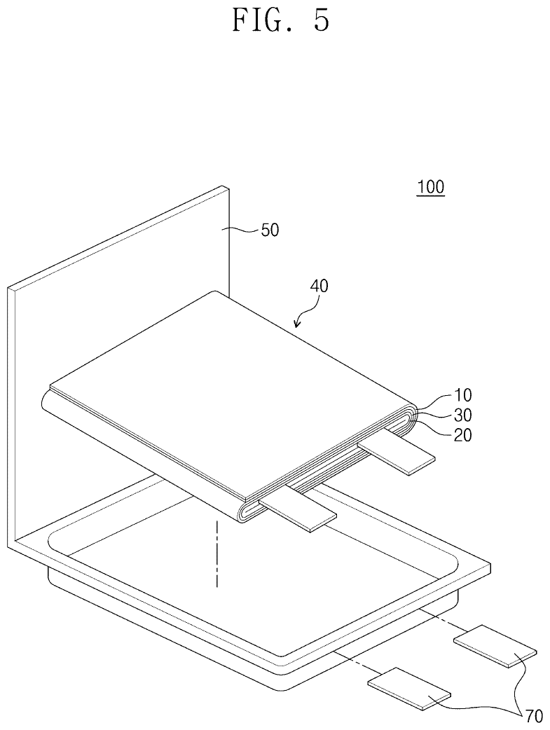

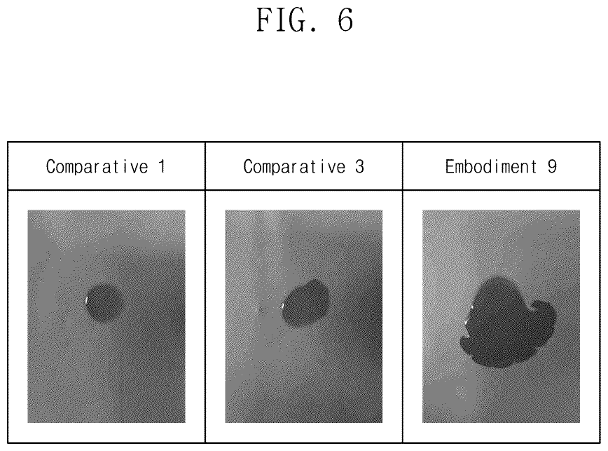

Based on a shape of a rechargeable lithium battery, the rechargeable lithium battery may be classified into cylindrical, prismatic, pouch, and coin types or kinds. In FIGS. 2 to 5 each is a simplified diagram illustrating a rechargeable lithium battery according to one or more embodiments, FIG. 2 is a cylindrical rechargeable lithium battery, FIG. 3 is a prismatic rechargeable lithium battery, and FIGS. 4 and 5 are pouch-type or -kind rechargeable lithium batteries. Referring to FIGS. 2 to 4, a rechargeable lithium battery 100 may include an electrode assembly 40 in which a separator 30 is between a positive electrode 10 and a negative electrode 20, and may also include a casing 50 in which the electrode assembly 40 is accommodated. The positive electrode 10, the negative electrode 20, and the separator 30 may be impregnated in/with an electrolyte. The rechargeable lithium battery 100 may include a sealing member 60 that seals the casing 50 as illustrated in FIG. 2. In one or more embodiments, as illustrated in FIG. 3, the rechargeable lithium battery 100 may include a positive electrode lead tab 11, a positive electrode terminal 12, a negative electrode lead tab 21, and a negative electrode terminal 22. In FIGS. 4 and 5, the rechargeable lithium battery 100 may include an electrode tab 70, or a positive electrode tab 71 and a negative electrode tab 72, which electrode tab 70 serves as an electrical path to externally induce a current generated in the electrode assembly 40.

The rechargeable lithium battery according to one or more embodiments of the present disclosure may be applied to automotive vehicles, mobile phones, and/or any other suitable electrical devices, but embodiments of the present disclosure are not limited thereto.

A rechargeable lithium battery according to one or more embodiments of the present disclosure may include a positive electrode including a positive electrode active material, a negative electrode including a negative electrode active material, and the electrolyte for the rechargeable lithium battery as described in one or more embodiments.

The rechargeable lithium battery may be applied to automotive vehicles, mobile phones, and/or any other suitable electrical devices, but embodiments of the present disclosure are not limited thereto.

The positive electrode active material may include lithium composite oxide as represented by Chemical Formula 4.

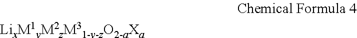

The subscripts x, a, y, and z may satisfy the relationship of 0.5≤x≤1.8, 0≤a≤0.05, 0<y≤1, 0≤z≤1, and 0≤y+z≤1.

M¹, M², and M³ may each independently include at least one element selected from among metals, such as nickel (Ni), cobalt (Co), manganese (Mn), aluminum (Al), boron (B), barium (Ba), calcium (Ca), cerium (Ce), chromium (Cr), iron (Fe), molybdenum (Mo), niobium (Nb), silicon (Si), strontium (Sr), magnesium (Mg), titanium (Ti), vanadium (V), tungsten (W), zirconium (Zr), lanthanum (La), and a combination thereof.

X may include at least one element selected from among fluorine (F), sulfur (S), phosphorus (P), and chlorine (Cl).

In one or more embodiments, the positive electrode active material may include at least one selected from among LiCoO₂, LiNiO₂, LiMnO2, LiMn₂O₄, LiNiₐMn_{b}Co_{C}O₂ (where a+b+c=1), LiNiₐMn_{b}Co_{c}AldO₂ (where a+b+c+d=1), and LiNiₑCo_{f}AgO₂ (where e+f+g=1).

In Chemical Formula 4, y may be 0.8≤y≤1, z may be 0≤z≤0.2, and M¹ may be Ni.

For example, the positive electrode active material selected from among LiNi_{b}Mn_{c}Co_{d}O₂ (where b+c+d=1), LiNi_{b}Mn_{c}Co_{d}AlₑO₂ (where b+c+d+e=1), and LiNi_{b}Co_{d}AlₑO₂ (where b+d+e=1) may be a high-nickel-based positive electrode active material.

In one or more embodiments, the negative electrode active material may include at least one selected from among graphite and silicon composites.

If (e.g., when) the negative electrode active material includes both (e.g., concurrently) a silicon composite and graphite, the silicon composite and the graphite may be in the form of a mixture, and in one or more embodiments, the silicon composite and the graphite may be included in a weight ratio of about 1:99 to about 50:50. For example, the silicon composite and the graphite may be included in a weight ratio of about 3:97 to about 20:80 or about 5:95 to about 20:80.

The silicon composite may include a core including silicon-based particles and an amorphous (e.g., non-crystalline) carbon coating layer, and the silicon-based particle may include at least one selected from among a silicon-carbon composite, SiOₓ (where 0<x≤2; e.g., SiO₂), and a silicon alloy. For example, the silicon-carbon composite may include a core including silicon particles and crystalline carbon, and may also include an amorphous (e.g., non-crystalline) carbon coating layer on a surface of the core.

The crystalline carbon may include graphite, for example, natural graphite, artificial graphite, or a mixture thereof.

Embodiments and Comparatives of the present disclosure are described in more detail. However, the following examples are only examples of the present disclosure, and embodiments of the present disclosure are not limited to the following examples.

### EMBODIMENTS AND COMPARATIVES

### (1) Preparation of Electrolyte

1.3 M of LiPF₆ was dissolved in a non-aqueous (e.g., water-insoluble) organic solvent containing a first compound and a carbonate-based solvent mixed in a volume ratio of Table 1, and a first additive and a second additive were added and mixed to prepare an electrolyte. For example, electrolytes according to Embodiments and Comparatives were prepared with compositions of Table 1.

A compound as represented by Chemical Formula 1-1 was used as the first compound, a compound as represented by Chemical Formula 2 was used as the first additive, and a compound as represented by Chemical 3-1 was used as the second additive.

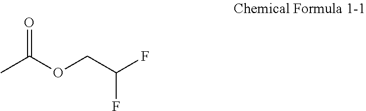

### 2,2-difluoroethyl acetate

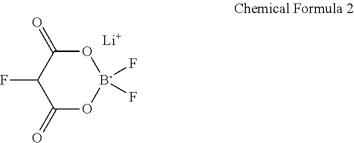 [SMILES: O=C1O[B-](F)(F)OC(=O)C1F ; [Li+]]

### Lithium Fluoromalonato(difluoro)borate

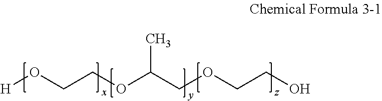

Poly(ethylene glycol)-block-poly(propylene glycol)-block-poly(ethylene glycol) (PEG-b-PPG-b-PEG, CAS No 9003-11-6, x=1˜20, y=1˜20, z=1˜20, number average molecular weight (Mₙ)=1,100 g/mol)

TABLE 1

| | Non-aqueous (e.g., water- | | | | | |
|---|---|---|---|---|---|---|
| | insoluble) organic solvent (vol %) | | | | | |
| | | | 2,2-difluoro | Additive (wt %) | | |
| | Ethylene | Propylene | ethyl | propyl | | Chemical |
| | carbonate | carbonate | acetate | propionate | Chemical | Formula |
| | (EC) | (PC) | (DFEA) | (PP) | Formula 2 | 3-1 |
| Comparative | 10 | 15 | 0 | 75 | 0 | 0 |
| 1 | | | | | | |
| Comparative | 10 | 15 | 0 | 75 | 1 | 0 |
| 2 | | | | | | |
| Comparative | 10 | 15 | 0 | 75 | 0 | 1 |
| 3 | | | | | | |
| Comparative | 10 | 15 | 75 | — | 0 | 0 |
| 4 | | | | | | |
| Embodiment | 10 | 15 | 75 | — | 1 | 0.1 |
| 1 | | | | | | |
| Embodiment | 10 | 15 | 75 | — | 1 | 0.2 |
| 2 | | | | | | |
| Embodiment | 10 | 15 | 75 | — | 1 | 0.5 |
| 3 | | | | | | |
| Embodiment | 10 | 15 | 75 | — | 1 | 1.0 |
| 4 | | | | | | |
| Embodiment | 10 | 15 | 75 | — | 2 | 1.0 |
| 5 | | | | | | |
| Embodiment | 10 | 15 | 75 | — | 2 | 2.0 |
| 6 | | | | | | |
| Embodiment | 10 | 15 | 60 | 15 | 1 | 1.0 |
| 7 | | | | | | |
| Embodiment | 10 | 15 | 75 | — | 5 | 1.0 |
| 8 | | | | | | |
| Embodiment | 10 | 15 | 75 | — | 1 | 5.0 |
| 9 | | | | | | |

For reference, in Table 1, a molarity (M) of the lithium salt may refer to a quantity (in mol) of the lithium salt dissolved in 1 L of the electrolyte, a volume ratio of the non-aqueous (e.g., water-insoluble) organic solvent may refer to a volume ratio of EC:PC:DFEA, EC:PC:PP, or EC:PC:DFEA:PP, and wt % of the additive may refer to a relative weight of the additive relative to (e.g., based on) the total 100 wt % of the electrolyte (lithium salt+non-aqueous (e.g., water-insoluble) organic solvent) exclusive of the additive.

### (2) Fabrication of Rechargeable Lithium Battery

97 wt % of LiCoO₂ (LCO) as a positive electrode active material, 0.5 wt % of artificial graphite powder as a conductive (e.g., electrically conductive) material, 0.8 wt % of carbon black (Ketjen black), 0.2 wt % of acrylonitrile rubber, and 1.5 wt % of polyvinylidenefluoride (PVdF) were mixed and added to N-methyl-2-pyrrolidone (NMP), and then the mixture were stirred for 30 minutes by using a mechanical agitator to prepare a positive electrode active material slurry. A doctor blade was used to coat the positive electrode active material slurry of 60 μm in thickness on an aluminum current collector of 20 μm in thickness, dried in a hot-air drier for 0.5 hours at 100° C., dried again for 4 hours at 120° C. under a vacuum condition, and then roll-pressed to manufacture a positive electrode.

98 wt % of a negative electrode active material containing artificial graphite and silicon composite mixed in a volume ratio of 95.8:4.2, 1 wt % of styrene-butadiene rubber (SBR), and 1 wt % of carboxymethyl cellulose (CMC) were mixed and added to distilled water, and then stirred for 60 minutes by using a mechanical agitator to prepare a negative electrode active material slurry. A doctor blade was used to coat the negative electrode active material slurry of 60 μm in thickness on a copper current collector of 10 μm in thickness, dried in a hot-air drier for 0.5 hours at 100° C., dried again for 4 hours at 120° C. under a vacuum condition, and then roll-pressed to manufacture a negative electrode.

The positive electrode, the negative electrode, and a polyethylene separator of 16 μm in thickness were assembled to manufacture an electrode assembly, and the electrolyte was introduced to fabricate a rechargeable lithium battery.

### Evaluation 1: Flame Retardancy

A flash point was measured for the rechargeable lithium batteries fabricated in Embodiments and Comparatives. The flash point measurement was executed by using Miniflash FP Vision commercially available from Grabner Instruments Messetechnik GmbH. A sample was placed into a sealed container (closed cup) and the sample in the container was slowly heated. A gas in the container was exposed and a flame was applied at regular intervals, and a temperature at which the flame was instantaneously ignited was recorded. The results are shown in Table 2.

### Evaluation 2: High-Temperature Lifespan Characteristics

For each of the rechargeable lithium batteries fabricated in Embodiments and Comparatives, a charge-discharge cycle was executed 400 times under the conditions of 45° C., 2.0 C charge (CC/CV, 4.53 V, 0.05 C cut-off)/1.0 C discharge (CC, 3.0 V cut-off), and then characteristic values of the rechargeable lithium batteries were measured. A thickness increase rate and a capacity retention rate were calculated according to Equation 1 and Equation 2. The results are described in Table 2.

$$Thickness increase rate ( \% ) = [ ( thickness of cell battery after 400 cycles - initial thickness of cell battery ) / ( initial thickness of cell battery ) ] \times 100 \qquad Equation 1$$

For example, a press-type or -kind thickness gauge commercially available from Mitutoyo Corporation was used such that a pouch cell was positioned between press plates and then a thickness of the cell was measured while being pressed with a weight of 300 g.

$$Capacity retention rate ( \% ) = ( discharge capacity after 400 cycles / initial discharge capacity ) \times 100 \qquad Equation 2$$

TABLE 2

| | | High-temperature lifespan | |
|---|---|---|---|
| | | Thickness | Capacity |
| | Flame retardancy | increase rate | retention rate |
| Category | Flash point (° C.) | (%) at 45° C. | (%) at 45° C. |
| Comparative 1 | 29 | 18.7 | 70 |
| Comparative 2 | 29 | 20.1 | 67 |
| Comparative 3 | 29 | 17.3 | 63 |
| Comparative 4 | Non-combustible | 23.2 | 61 |
| Embodiment 1 | Non-combustible | 20.0 | 68 |
| Embodiment 2 | Non-combustible | 19.6 | 69 |
| Embodiment 3 | Non-combustible | 18.9 | 75 |
| Embodiment 4 | Non-combustible | 19.9 | 67 |
| Embodiment 5 | Non-combustible | 20.8 | 71 |
| Embodiment 6 | Non-combustible | 19.7 | 63 |
| Embodiment 7 | Non-combustible | 21.7 | 61 |
| Embodiment 8 | Non-combustible | 22.8 | 52 |
| Embodiment 9 | Non-combustible | 20.9 | 55 |

### Evaluation 3: High-Temperature Storage

Each of the rechargeable lithium batteries fabricated according to Embodiments and Comparatives was charged under the condition of 45° C., 0.5 C, 4.53 V, and 0.05 C cut-off, and initial characteristic values of the rechargeable lithium battery were measured. The rechargeable lithium battery was left at 60° C. for 28 days, and then characteristic values of the rechargeable lithium battery were measured. A DC-IR change rate (or resistance increase rate) was calculated according to Equation 3. A current of 1 C was applied for 10 seconds, and dR=dV/dI was used to measure a direct-current internal resistance (DCIR). The results are described in Table 3.

$$DC - IR change rate ( \% ) = ( DC - IR after 400 cycles / initial DC - IR ) \times 100 \qquad Equation 3$$

TABLE 3

| Category | DC-IR change rate (%) at 45° C. |
|---|---|
| Comparative 1 | 180 |
| Comparative 2 | 163 |
| Comparative 3 | 175 |
| Comparative 4 | 192 |
| Embodiment 1 | 165 |
| Embodiment 2 | 163 |
| Embodiment 3 | 151 |
| Embodiment 4 | 164 |
| Embodiment 5 | 156 |
| Embodiment 6 | 183 |
| Embodiment 7 | 188 |
| Embodiment 8 | 198 |
| Embodiment 9 | 196 |

### Evaluation 4: Impregnation

Impregnation was evaluated for the rechargeable lithium batteries according to Embodiments and Comparatives. The negative electrode according to Embodiment 1 was manufactured as a specimen with dimensions of 3 cm in width and 4 cm in length. 1 g of the electrolyte according to Embodiment 1 was dropped onto the specimen and left for 1 minute. Afterwards, among 100% of an area of the electrolyte dropped on the specimen, an amount of the electrolyte immersed in the specimen was evaluated as a value from 0 to 5 according to the following criteria, and evaluated results are listed in Table 4.

0: A case in which an area ratio of the electrolyte immersed in the specimen after 1 minute is equal to or greater than about 0% and less than about 10%

1: A case in which an area ratio of the electrolyte immersed in the specimen after 1 minute is equal to or greater than about 10% and less than about 20%

2: A case in which an area ratio of the electrolyte immersed in the specimen after 1 minute is equal to or greater than about 20% and less than about 40%

3: A case in which an area ratio of the electrolyte immersed in the specimen after 1 minute is equal to or greater than about 40% and less than about 60%

4: A case in which an area ratio of the electrolyte immersed in the specimen after 1 minute is equal to or greater than about 60% and less than about 80%

5: A case in which an area ratio of the electrolyte immersed in the specimen after 1 minute is equal to or greater than about 80% and less than about 100%

Substantially the same method was used to evaluate Embodiments 2 to 9 and Comparatives 1 to 4.

TABLE 4

| Category | Impregnation of electrolyte to negative electrode |
|---|---|
| Comparative 1 | 1 |
| Comparative 2 | 1 |
| Comparative 3 | 3 |
| Comparative 4 | 1 |
| Embodiment 1 | 1 |
| Embodiment 2 | 1 |
| Embodiment 3 | 1 |
| Embodiment 4 | 2 |
| Embodiment 5 | 3 |
| Embodiment 6 | 4 |
| Embodiment 7 | 3 |
| Embodiment 8 | 3 |
| Embodiment 9 | 5 |

### Comprehensive Evaluation

Referring to Tables 1 and 2, it may be observed that the flame retardancy and the lifespan characteristics at high voltages and high temperatures are more excellent in the cases (Embodiments 1 to 9) each of which uses the electrolyte added with the first compound, the first additive, and the second additive according to the present disclosure (Embodiments 1 to 9) than in the cases of Comparatives.

Referring to Tables 1 and 3, it may be found that storage characteristics at high voltages and high temperatures are more excellent in the cases (Embodiments 1 to 9) each of which uses the electrolyte according to the present disclosure than in the cases of Comparatives.

Referring to Tables 1 and 4, it may be ascertained that impregnation characteristics of the electrolyte to the negative electrode are more improved or enhanced in the cases (Embodiments 1 to 9) each of which uses the electrolyte according to the present disclosure than in the cases of Comparatives.

An electrolyte for a rechargeable lithium battery according to one or more embodiments may exhibit or provide an effect of improvement or enhancement of the lifespan characteristics and stability (e.g., electrochemical stability, thermal stability, and/or physical stability) at high voltage conditions if (e.g., when) the rechargeable lithium battery is activated.

A rechargeable lithium battery including the electrolyte as described in one or more embodiments may have superior performance at relatively high voltages.

While the subject matter of the present disclosure has been described in connection with what is presently considered to be practical embodiments, it is to be understood that the present disclosure is not limited to the disclosed embodiments. In contrast, it is intended to cover one or more suitable modifications and equivalent arrangements included within the spirit and scope of the appended claims and equivalents thereof. Therefore, it will be understood that one or more embodiments described above are just illustrative but not limitative in all aspects.

What is claimed is:

1. An electrolyte for a rechargeable lithium battery, comprising:
a non-aqueous organic solvent comprising a first compound as represented by Chemical Formula 1;
a lithium salt;
a first additive as represented by Chemical Formula 2; and
a second additive as represented by Chemical Formula 3, 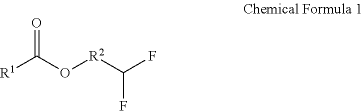
wherein, in Chemical Formula 1,
R¹ is a substituted or unsubstituted C1 to C6 alkyl group or a substituted or unsubstituted C5 to C12 aryl group, and
R² is a direct bond or a C1 to C6 alkylene group, 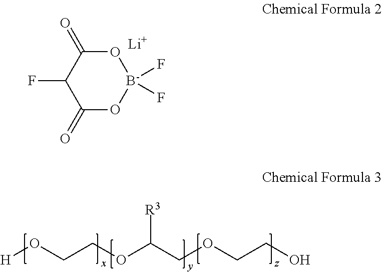
wherein, in Chemical Formula 3,
R³ is hydrogen or a substituted or unsubstituted C1 to C10 alkyl group, and
x, y, and z are each independently an integer of 1 to 20.

2. The electrolyte as claimed in claim 1, wherein, in Chemical Formula 1,
R¹ is a substituted or unsubstituted C1 to C6 alkyl group, and
R² is a C1 to C6 alkylene group.

3. The electrolyte as claimed in claim 1, wherein Chemical Formula 1 is 2,2-difluoroethyl acetate (DFEA) as represented by Chemical Formula 1-1,

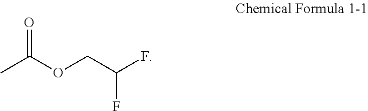

4. The electrolyte as claimed in claim 1, wherein Chemical Formula 3 is poly(ethylene glycol)-block-poly(propylene glycol)-block-poly(ethylene glycol) (PEG-b-PPG-b-PEG) as represented by Chemical Formula 3-1, 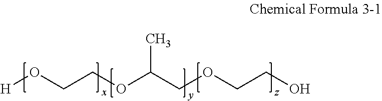
wherein, in Chemical Formula 3-1,
x, y, and z are each independently an integer of 1 to 20.

5. The electrolyte as claimed in claim 1, wherein the first compound is included in an amount of about 50 vol % to about 85 vol % based on 100 vol % of a total volume of the non-aqueous organic solvent.

6. The electrolyte as claimed in claim 1, wherein the first additive is included in an amount of about 0.1 wt % to about 5 wt % based on 100 wt % of a total weight of the electrolyte.

7. The electrolyte as claimed in claim 1, wherein the second additive is included in an amount of about 0.01 wt % to about 5 wt % based on 100 wt % of a total weight of the electrolyte.

8. The electrolyte as claimed in claim 1, wherein the second additive is included in an amount of about 0.01 wt % to about 1 wt % based on 100 wt % of a total weight of the electrolyte.

9. The electrolyte as claimed in claim 1, wherein an amount of the first additive included in the electrolyte is greater than an amount of the second additive included in the electrolyte.

10. The electrolyte as claimed in claim 1, wherein the non-aqueous organic solvent further comprises a carbonate-based solvent.

11. The electrolyte as claimed in claim 1, wherein the non-aqueous organic solvent comprises ethylene carbonate (EC), propylene carbonate (PC), and the first compound in a volume ratio of about 1:a:b,
wherein a is about 1 to 3, and
wherein b is about 5 to about 8.

12. The electrolyte as claimed in claim 1, wherein the lithium salt comprises at least one selected from among LiPF₆, LiBF₄, LiSbF₆, LiAsF₆, Li(FSO₂)₂N (lithium bis(fluorosulfonyl)imide, LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (where x and y are each independently an integer of 1 to 20), LiCl, LiI, LiB(C₂O₄)₂ (lithium bis(oxalato)borate, LiBOB), LiDFOB (lithium difluoro(oxalato)borate), and Li[PF₂(C₂O₄)₂] (lithium difluorobis(oxalato)phosphate).

13. The electrolyte as claimed in claim 12, wherein a concentration of the lithium salt is in a range of about 0.1 M to about 2.0 M.

14. A rechargeable lithium battery, comprising:
a positive electrode that comprises a positive electrode active material;
a negative electrode that comprises a negative electrode active material; and
the electrolyte as claimed in claim 1, wherein the electrolyte is for the rechargeable lithium battery.

15. The rechargeable lithium battery as claimed in claim 14, wherein the positive electrode active material comprises lithium composite oxide as represented by Chemical Formula 4, 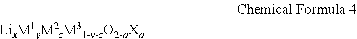
wherein 0.5≤x≤1.8, 0≤a≤0.05, 0<y≤1, 0≤z≤1, and 0≤y+z≤1,
M¹, M², and M³ each independently comprise at least one selected from among Ni, Co, Mn, Al, B, Ba, Ca, Ce, Cr, Fe, Mo, Nb, Si, Sr, Mg, Ti, V, W, Zr, La, and a combination thereof, and
X comprises at least one element selected from among F, S, P, and Cl.

16. The rechargeable lithium battery as claimed in claim 14, wherein the negative electrode active material comprises a carbon-based negative electrode active material, a Si-based negative electrode active material, a Sn-based negative electrode active material, or a combination thereof.

17. The rechargeable lithium battery as claimed in claim 14, wherein the rechargeable lithium battery is a cylindrical rechargeable lithium battery, a prismatic rechargeable lithium battery, or a pouch-type rechargeable lithium battery.
